(19) United States
(12) Patent Application Publication
(10) Pub. No.: US 2022/0097192 A1
(43) Pub. Date: Mar. 31, 2022

(54) Tool State Detection System

(71) Applicant: Hitachi, Ltd., Tokyo (JP)

(72) Inventors: Kenji NISHIKAWA, Tokyo (JP); Yasushi SANO, Tokyo (JP); Ami SASAKI, Tokyo (JP)

(21) Appl. No.: 17/377,854

(22) Filed: Jul. 16, 2021

(30) Foreign Application Priority Data
Sep. 28, 2020 (JP) 2020-161796

(51) Int. Cl. B23Q 17/09

(52) U.S. Cl. CPC B23Q 17/0995; B23Q 2717/006; B23Q 17/0971

(57) ABSTRACT

Provided is a tool state detection system capable of improving usability. A tool state detection system that detects a state of a tool attached to a machining device includes: a detection device which is formed separately from a tool holder that holds the tool and is detachably attached to the tool holder, the detection device being configured to detect the state of the tool and output measurement data; and a data analysis device which provided to be communicable with the detection device, the data analysis device being configured to analyze the measurement data from the detection device. As a result, usability for a user is improved since the detection device can be formed separately from the tool holder and be detachably attached to the tool holder.

### BACKGROUND OF THE INVENTION

### 1. Field of the Invention

The present invention relates to a tool state detection system.

### 2. Description of the Related Art

A device for detecting an abnormality or a situation change of a tool is described in WO2017/002762 (PTL 1). According to description of this publication, “Provided is a rotary machine tool such as an end-mill, drill, tap or the like, with which it is possible to measure, in real time, the damage, breakage or extreme wear thereof, without performing a special process or the like. The rotary machine tool equipped with sensor for real-time detection of state of the present invention is connected to the tip of a rotary machining device that can rotate about a rotary axis, and rotates about the same rotary axis, the tip coming into contact with the member to be machined, thereby cutting the member to be machined. The rotary machine tool is provided with at least: a sensor installation hole which has a vertically long shape having a central axis line approximately centering on the axis of rotation, the rear end being open to the exterior at the rear end of the main body of the rotary cutting tool, and the tip being above the tip of the main body of the rotary machine tool and closed off from the exterior; a sensor that is inserted from the rear end of the sensor installation hole, is positioned at the tip of the sensor installation hole and detects the state at the positioned position; and a sensor insertion hole that is connected to one end of the sensor and is coupled with the rear end of the rotary cutting tool.”

On the other hand, a technique of detecting wear of a tool and managing a cutting process is described in JP-A-2020-015148 (PTL 2). According to description of this publication, “The cutting management system comprises: a cutting control part that acquires cutting information detected in cutting processing using a cutting device, which includes at least first information showing a state of the cutting processing and second information that increases according to the cutting processing and tool information for identifying a cutting tool performing the cutting processing, and makes a cutting information memorizing part to memorize the acquired cutting information and the tool information, associating the information with each other; and a management processing part that produces quantity information relating to use of the cutting tool on the basis of the first information and the second information included in the cutting information, and executes predetermined management processing to the cutting tool on the basis of the produced quantity information.”

PTL 1 is a technique of a rotary machining tool equipped with a sensor for real-time detection of a state of a tool. The sensor is provided in a tool holder and thus usability is poor. In a general machining process of a machine component, since a plurality of tools having different shapes are used, it is necessary to design and manufacture a rotary machining tool equipped with a sensor each time a tool has a different shape, which takes time and effort.

PTL 2 estimates a life of a cutting tool and calculates an optimum condition during machining by using machine learning, and there is room for improvement in handling sensor data with a large amount of noise.

### SUMMARY OF THE INVENTION

The invention has been made in view of the above problems, and an object of the invention is to provide a tool state detection system capable of improving usability for a user.

In order to solve the above-described problems, a tool state detection system according to one aspect of the invention detects a state of a tool attached to a machining device. The tool state detection system includes: a detection device which is formed separately from a tool holder that holds the tool and is detachably attached to the tool holder, the detection device being configured to detect the state of the tool and output measurement data; and a data analysis device which provided to be communicable with the detection device, the data analysis device being configured to analyze the measurement data from the detection device.

According to the invention, the usability for the user is improved since the detection device can be formed separately from the tool holder and be detachably attached to the tool holder.

### BRIEF DESCRIPTION OF THE DRAWINGS

FIG. 1 is an overall configuration diagram of a tool state detection system;

FIG. 2 is an external perspective view of a detection device attached to a tool holder;

FIG. 3 is a longitudinal cross-sectional view of FIG. 2;

FIG. 4 is a block diagram of a prior signal processing unit;

FIG. 5 is an example of a screen for outputting measurement data;

FIG. 6 is an example of contents stored in a process data storage unit;

FIG. 7 is a block diagram of a data analysis unit;

FIG. 8 is an example of a screen for outputting an analysis result;

FIG. 9 is a characteristic diagram showing a relationship between a wear amount of a tool and an abnormality degree;

FIG. 10 is an overall configuration view of a tool state detection system according to a second embodiment;

FIG. 11 is an example of an operation flow of the tool state detection system;

FIG. 12 is an example of a method for utilizing a tool state detection system according to a third embodiment;

FIG. 13 is an enlarged external perspective view showing a balance weight unit provided in a detection device according to a fourth embodiment;

FIG. 14 is an external perspective view of a balance weight unit to which a weight having a different weight is attached; and

FIG. 15 is an external perspective view of a balance weight unit to which another weight having a different weight is attached.

### DESCRIPTION OF THE PREFERRED EMBODIMENTS

Hereinafter, an embodiment of the invention will be described with reference to the drawings. The present embodiment provides a system that can be attached to tool holders having various shapes and can measure a state change such as wear of a tool with high accuracy. In the system, an abnormality of the tool can also be detected by an algorithm using machine learning or the like.

In the present embodiment, the system includes a detection device that is externally attachable to a tool holder and a data analysis device that is communicable with the detection device and analyzes a state of the tool. In the present embodiment, a sensor unit of the detection device is provided at a portion close to a machining point by the tool, and thus it is possible to measure the state change of the tool with high accuracy.

The present embodiment includes at least the following aspects.

(1) The detection device includes the sensor unit coaxially fixed to the tool holder, the sensor unit including a sensor therein provided close to a tip end of the tool, and a transmission and reception unit provided above the tool holder, the transmission and reception unit being configured to receive a signal measured by the sensor and transmit the signal to the data analysis device.

(2) The transmission and reception unit includes abase that transmits the signal to the data analysis device, a battery that ensures power for transmission, and a terminal that fills the battery.

(3) The sensor unit may include an acceleration sensor fixed in an orthogonal arrangement.

(4) The sensor unit may include at least one of the acceleration sensor, a force sensor, a temperature sensor, a sound sensor, and an acoustic emission (AE) sensor.

(5) In order to not interfere with an arm of an automatic tool changer (ATC) of a machining device, the detection device may be attached to the tool holder in a state in which a contact position of the arm is exposed.

(6) The data analysis device may include a reception device, a prior signal processing unit, a data analysis unit, a process data storage unit, and a learning data storage unit.

(7) The prior signal processing unit may include steps of starting measurement, inputting setting parameters, selecting signal processing, executing signal processing, and performing FFT processing.

(8) The data analysis unit may include a feature amount selection step, a feature amount calculation step, an analytical parameter input step, a state determination step, a tool wear database, and an analysis result output step.

(9) The system may have a function of issuing a control command to a machining device based on a determination result and operating the machining device.

(10) The system may have a function of connecting the data analysis device to a network and allowing a plurality of relevant parties to access the network through terminals.

### First Embodiment

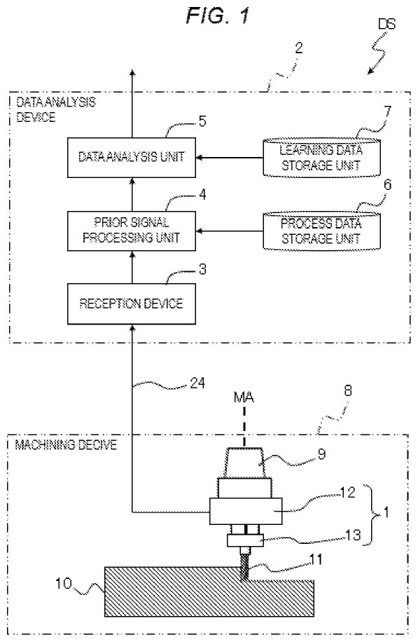

The first embodiment will be described with reference to FIGS. 1 to 9. FIG. 1 is an overall configuration view of a tool state detection system DS. The tool state detection system DS can also be referred to as a tool state data analysis apparatus DS.

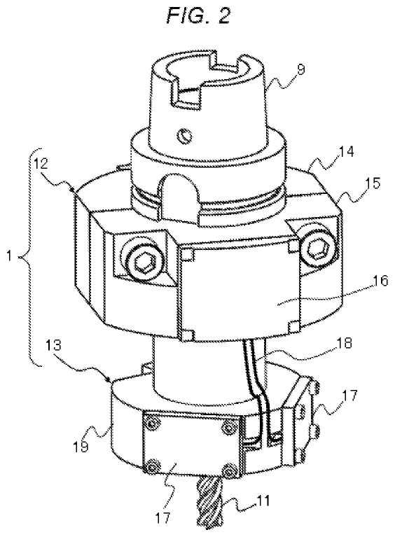

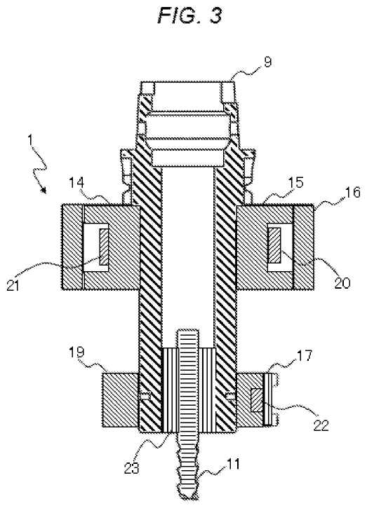

The tool state detection system DS includes a detection device 1 and a data analysis device 2. The tool state detection system DS is used in, for example, a cutting process. In the cutting, a tool 11 scrapes a work material 10 and forms the work material 10 into a desired shape. The tool 11 is fixed to a tool holder 9. The tool holder 9 is generally fixed to a main spindle MA of a machining device 8. When the main spindle MA rotates, the tool holder 9 and the tool 11 rotate together. Hereinafter, the tool holder 9 is abbreviated to the holder 9. Here, a detailed configuration example of the detection device 1 will be described later with reference to FIGS. 2 and 3.

When the tool 11 mounted on the holder 9 rotates, the work material 10 is cut. During machining, a vibration, a load, a temperature and the like change. The tool state detection system DS measures and analyzes values of parameters such as the vibration, the load, and the temperature by using the detection device 1 to be described later. The detection device 1 is detachably fixed to an outer side of the holder 9, and rotates together with the holder 9.

In the present embodiment, an example in which the vibration during machining is targeted will be described. In addition to the vibration, a force, the temperature, or another changing parameter may be measured. The vibration generated by the machining is measured by the detection device 1, and is input to a reception device 3 which is an input portion of the data analysis device 2. Since the tool 11 rotates at a high speed, the detection device 1 rotating together with the holder 9 and the data analysis device 2 provided away from the holder 9 are wirelessly connected to each other. For example, Wi-Fi (registered trademark), Bluetooth (registered trademark) and other high-speed wireless communication standards can be used. In addition, instead of wireless communication, the detection device 1 and the data analysis device 2 may be in a wired connection by using a rotary connector, a slip ring, or the like.

A signal (measurement data) output from the detection device 1 is received by the reception device 3, and a raw waveform signal is input from the reception device 3 to a prior signal processing unit 4. However, the raw waveform signal has a large amount of noise, and thus a change in the wear of the tool 11 may not be captured. In a factory or the like that uses the machining device 8, periodic or non-periodic vibration, electromagnetic noise, or the like from other surrounding devices may affect the detection device 1. Therefore, in the present embodiment, the prior signal processing unit 4 is provided between the reception device 3 and the data analysis unit 5 so that the noise is removed from the raw waveform signal by the prior signal processing unit 4.

In the prior signal processing unit 4, a process of a detection target is determined, and measurement of a range for determining abnormality due to tool wear is started. A database of a process data storage unit 6 is used to determine the process of the detection target. The waveform from which the noise has been removed by the prior signal processing unit 4 is input to the next data analysis unit 5.

The data analysis unit 5 uses teacher data accumulated in a database of a learning data storage unit 7 to determine an abnormality degree of the tool wear by using machine learning or the like. A processing result of the data analysis unit 5 is output and displayed as an analysis result to an external device, such as a monitor display or a computer terminal.

FIG. 2 illustrates the configuration example of the detection device 1. The detection device 1 mainly includes two portions of a transmission and reception unit 12 and a sensor unit 13. The transmission and reception unit 12 and the sensor unit 13 are separated from each other in an axial direction of the holder 9 and are detachably fixed to the holder 9. The transmission and reception unit 12 is provided on a base end side of the holder 9. The sensor unit 13 is provided on a tip end side of the holder 9 close to the tool 11.

The transmission and reception unit 12 includes two housings of a power source unit 14 and an electronic circuit unit 15. By changing shapes of the two housings 14 and 15 or inserting a spacer on an inner peripheral side, the housings 14 and 15 also can be applied to the holder 9 having a different diameter. The two housings 14 and 15 are fastened to be detachably fixed to the holder 9 from an outer peripheral side of the holder 9.

The power source unit 14 and the electronic circuit unit 15 include configurations which are necessary to output the signal to the data analysis device 2, and are sealed by a housing cover 16. The housing cover 16 prevents a coolant or the like during machining from entering the transmission and reception unit 12. When the signal is wirelessly transmitted to the data analysis device 2, the housing cover 16 made of a synthetic resin can be used so that the wireless communication can be performed. The housing cover 16 is not limited to the synthetic resin, and may be formed of a waterproof material that is easily passed through by electromagnetic waves.

A sensor housing 19 formed separately from the holder 9 is detachably fixed to a tip end side (tool 11 side) of the holder 9. For example, by providing a gap or a notch on one side of the sensor housing 19 or by constituting the sensor housing 19 with a plurality of components, the sensor housing 19 can also be attached to the holder 9 having a different diameter from outside.

The sensor housing 19 has a sensor accommodation unit (described later in FIG. 3) in which a sensor 22 is provided. An opening unit of the sensor accommodation unit is sealed with a sensor cover 17. For example, when the vibration is measured by a uniaxial acceleration sensor, the sensor accommodation unit may be provided with a portion that fixes the acceleration sensor in an orthogonal direction. The acceleration sensor is in a wired connection with the electronic circuit unit 15 of the transmission and reception unit 12 through a cable 18. The cable 18 is drawn out from the sensor housing 19 and connected to the electronic circuit unit 15 through a surface of the holder 9. It is assumed that the coolant adheres to the cable 18 so that the cable 18 may be protected by a silicon tube or the like. A mounting hole or the like through which the cable 18 is inserted is also sealed in a liquid-tight manner.

FIG. 3 shows an example of a cross-sectional view of the detection device 1. Generally, the tool 11 is fixed to a tip end of the holder 9 by a holding component 23 such as a collet to be non-rotatable relative to the holder 9. The sensor housing 19 in which the sensor 22 is provided is fixed to the tip end of the holder 9.

A battery 21 serving as a power source is provided in the power source unit 14 of the transmission and reception unit 12. An electronic circuit board 20 that amplifies a signal of the sensor 22 and transmits a wireless signal is provided in the electronic circuit unit 15.

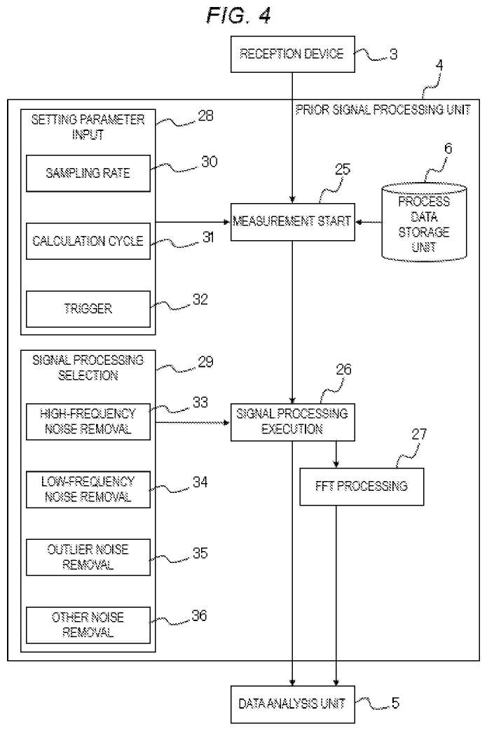

FIG. 4 shows a configuration example of the prior signal processing unit 4. The raw waveform signal input from the reception device 3 to the prior signal processing unit 4 proceeds to measurement start step 25, which is a “measurement start unit”. In step 25, in addition to the raw waveform signal, an initial input condition is set. The initial input condition is determined in setting parameter input step 28, which is a “setting parameter input unit”, and is necessary for starting the measurement.

The initial input condition includes, for example, a sampling rate 30 which is an interval during measurement, a calculation cycle 31 which is an interval when performing signal processing, and a trigger 32 which is a sign for starting the measurement.

In measurement start step 25, the process of the detection target is determined based on data stored in the database of the process data storage unit 6. A state of the tool 11 is determined only in a determined detection target process. In the present embodiment, life, abnormality, and the like of the tool 11 are determined.

When measurement is started under the condition determined in step 25, signal processing is performed in signal processing execution step 26 which is a “signal processing execution unit”.

In signal processing execution step 26, the signal processing is performed based on a method determined in advance in signal processing selection step 29 which is a “signal processing selection unit”. Examples of a signal processing method include high-frequency noise removal 33 such as a low-pass filter, low-frequency noise removal 34 such as a high-pass filter, outlier noise removal 35 for removing noise such as a spike, and other noise removal 36 such as a smoothing process. A signal processing method other than these methods may be used.

The number of processing methods selected in signal processing selection step 29 may be one or more. According to the processing method determined in signal processing selection step 29, the signal processing is performed in step 26. Since a waveform after signal processing may be analyzed in a frequency domain, the waveform is subject to FFT processing in FFT processing step 27 which is an “FFT processing unit”. Then, waveform signals of both the waveform after the FFT processing and the waveform without the FFT processing are input to the data analysis unit 5.

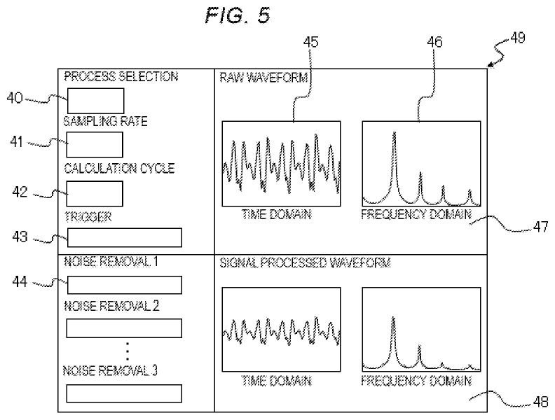

FIG. 5 is an example of a measurement waveform output screen 49 of the prior signal processing unit 4. In order to be capable of selecting or inputting necessary parameters, for example, the screen 49 can include input fields for inputting process selection 40, sampling rate 41, calculation cycle 42, and trigger 43. Any value may be input and selected from values prepared in advance.

The screen 49 may include a noise removal input unit 44 for inputting a type and the number of times of signal processing for noise removal. The screen 49 also includes display areas for outputting graphs of a raw waveform 47 and a signal processed waveform 48. In the display areas, two types of graphs in a time domain 45 and a frequency domain 46 are monitored.

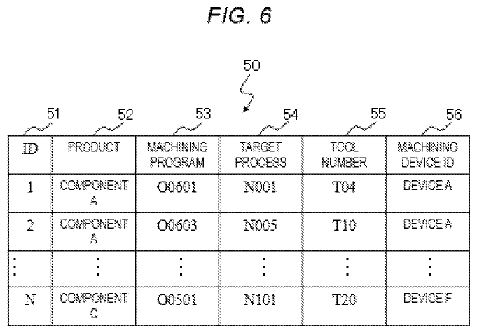

An example of a database association table 50 recorded in the process data storage unit 6 will be described with reference to FIG. 6. In the association table 50, for example, a target product 52, a machining program 53, a target process 54 in the machining program 53, a tool number 55, and a machining device ID 56 are recorded as a database. An ID 51 is determined for each combination, and the machining may be started by inputting the ID 51 to the measurement waveform output screen 49. For example, a trigger for starting the machining and/or the signal processing method may be automatically determined by inputting the ID 51 to the trigger 43.

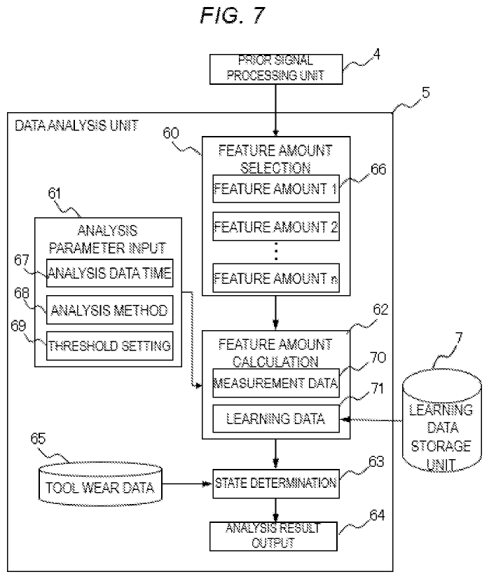

Processing of the data analysis unit 5 will be described with reference to FIG. 7. When the waveform after signal processing by the prior signal processing unit 4 is input, the data analysis unit 5 analyzes the state of the tool 11.

First, feature amount selection step 60, which is a “feature amount selection unit”, determines which parameter is set as a feature amount 66 in the input waveform. One or more feature amount 66 may be selected.

Feature amount calculation step 62, which is a “feature amount calculation unit”, sequentially calculates the feature amount 66 selected in step 66 at a predetermined interval. In analysis parameter input step 61, which is an “analysis parameter input unit”, analysis parameters for calculating the feature amount can be input in advance. The analysis parameters include, for example, analysis data time 67 which is a time interval for analysis, an analysis method 68 such as statistical analysis or machine learning, and threshold setting 69 for setting a threshold for determining the abnormality of the tool.

In feature amount calculation step 62, the feature amounts of both measurement data 70, which is the waveform input from the prior signal processing unit 4, and learning data 71, which serves as teacher data in advance and is stored in the learning data storage unit 7, are calculated.

In state determination step 63 which is a “state determination unit”, the state of the tool 11 is determined based on a calculation result in feature amount calculation step 62. In state determination step 63, a threshold value for determining the abnormality of the tool 11 is set by using tool wear data 65.

Analysis result output step 64, which is an “analysis result output unit”, outputs the determination result of state determination step 63.

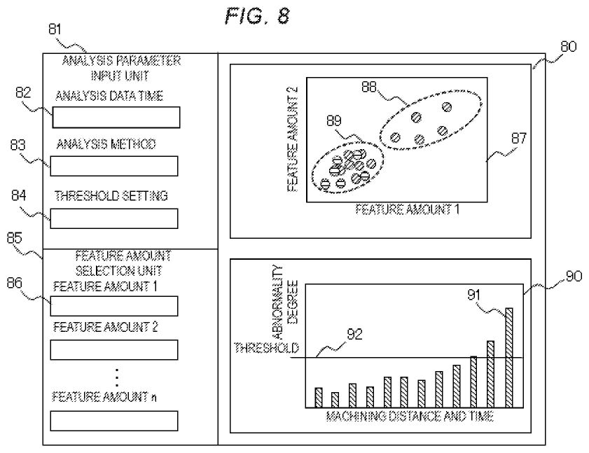

FIG. 8 shows an example of an analysis result output screen 80. In an analysis parameter input unit 81, analysis data time 82 which is a time interval for analysis, an analysis method 83 for selecting an analysis method such as statistical analysis or machine learning, and threshold setting 84 for inputting a threshold for determining a tool abnormality can be input, respectively. One or more feature amounts 86 can be input to a feature amount selection unit 85.

Examples of the feature amounts may include an average value, dispersion, a standard deviation, sharpness, an integral value, a differential value, a maximum value of a frequency peak, and a centroid value of a frequency spectrum of the waveform of the measurement data 70 obtained at the interval of the analysis data time 82.

In a plane plot 87, two feature amounts among the selected feature amounts can be plotted on a plane. For example, the measurement data 70 and the data measured or stored in the learning data storage unit 7 are normal data when the tool wear does not progress. In this case, the data are output to the vicinity of a normal region 89.

When the tool wear progresses, the feature amount changes, and thus the feature amount is output to an abnormal region 88 away from the normal region 89. A distance of the plot from the normal region can also be expressed by a dimensionless index of the abnormality degree. A situation of an increase in the abnormality degree as a machining distance progresses can be output through an abnormality degree graph 90. If a threshold value 92 of the tool abnormality is set, it can be determined that the tool 11 is abnormal when the abnormality degree reaches or exceeds the threshold value 92.

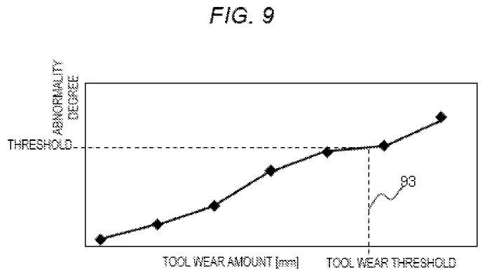

FIG. 9 shows an example of a database stored in the tool wear data 65 in which the tool wear and the abnormality degree necessary for determining the threshold 92 are associated with each other. It is assumed that the abnormality degree changes in a degree-correlated manner to some extent when the tool wear progresses. By determining a tool wear threshold 93 that indicates a certain tool wear amount to be abnormal, it is possible to determine the threshold of the abnormality degree.

According to the present embodiment configured as described above, the detection device 1 can be attached to the holder 9 in a so-called post-installation manner, and thus can be applied to state detection of various tools 11 so that usability for a user is improved. Further, according to the present embodiment, since the noise is removed by processing the waveform from the detection device 1 in advance, it is possible to appropriately extract the feature amount to be used for the machine learning and improve an accuracy of the state detection.

In the present embodiment, since the sensor unit 13 is attached to a location close to the tool 11, it is possible to sense various kinds of information derived from the state of the tool 11.

In the present embodiment, the light and small sensor unit 13 is disposed at the location close to the tool 11, and the transmission and reception unit 12 which is heavier and larger than the sensor unit 13 is disposed at a location far from the tool 11. Accordingly, the rotation of the tool 11 can be stabilized as compared with a case where the sensor unit 13 and the transmission and reception unit 12 are attached reversely.

### Second Embodiment

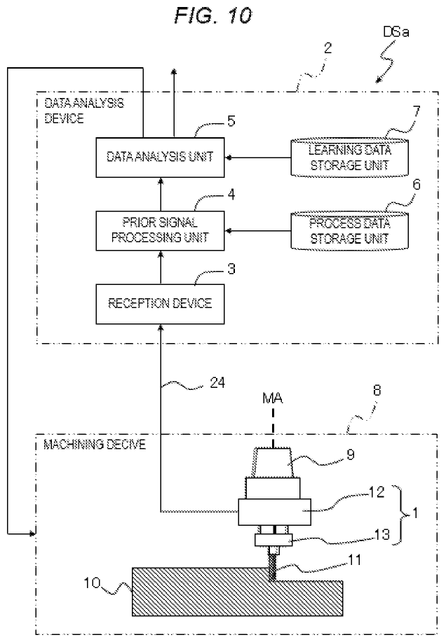

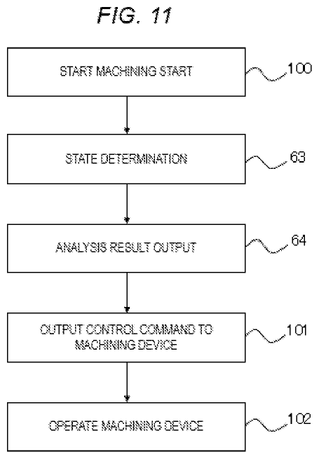

The second embodiment will be described with reference to FIGS. 10 and 11. In the following embodiments including the present embodiment, differences from the first embodiment will be mainly described. In a tool state detection system DSa of the present embodiment, a control command based on an analysis result in the data analysis device 2 is given to the machining device 8 to control the machining process of the machining device 8.

As shown in an overall configuration view of FIG. 10, according to the analysis result output by the data analysis unit 5, an operation of the machining device 8 is selected, and the selected operation is input to the machining device 8.

FIG. 11 shows an example of an operation flow. When machining is started in step 100, a state of the tool 11 is determined in step 63. The analysis result is output in step 64, and a control command is output to the machining device 8 in step 101.

An example of the control command will be described. For example, if the tool wear does not progress and no abnormality is determined, there is no particular additional command, and the process proceeds to the next step. In contrast, if the tool wear progresses and an abnormality is determined, an additional command for stopping the machining, controlling a rotation speed, controlling a feed speed, or the like is transmitted to the machining device 8. In step 102, the machining device 8 is operated in accordance with the control command.

The present embodiment configured in this manner also achieves the same operational effect as that of the first embodiment. Further, in the present embodiment, since the operation of the machining device 8 can be controlled based on the analysis result of the data analysis device 2, manufacturing quality of the machining device 8 can be stabilized so that the usability for the user is improved.

### Third Embodiment

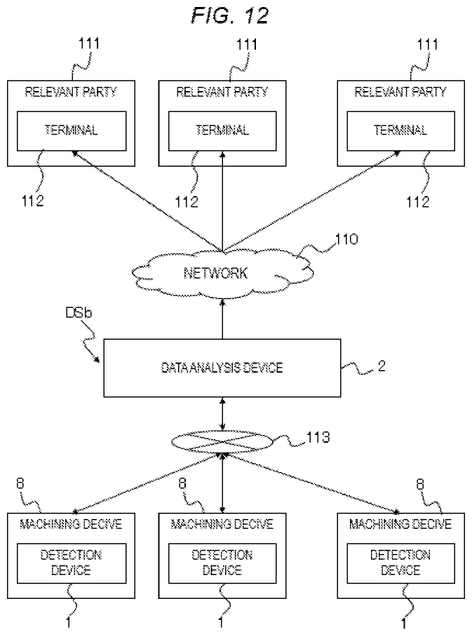

The third embodiment will be described with reference to FIG. 12. In the present embodiment, an example of solution deployment using a tool state detection system DSb will be described.

FIG. 12 shows an example of utilizing the tool state detection system DSb when connected to an upper network 110. Each of a plurality of machining devices 8 is provided with a detection device 1. One machining device 8 may be provided with a plurality of detection devices 1.

The measurement data 70 measured by the detection device 1 of each machining device 8 is aggregated and transmitted to the data analysis device 2. The data analysis device 2 of the present embodiment performs an abnormality determination at a time interval determined in real time. The determination result of the data analysis device 2 is uploaded to the network 110 in real time or at regular time intervals. The network 110 may be a so-called cloud system. The network 110 can be accessed through terminals 112, such as a personal computer, a tablet, or a mobile phone (including a so-called smartphone) possessed by each relevant party 111.

For example, when the relevant party 111 is a facility maintenance worker, an operation status of the machining device 8 obtained in the network 110 can be remotely monitored, and thus it is possible to calculate usage time of the machining device 8 and create a repair plan of the machining device 8 in cooperation with a machining device manufacturer.

When the relevant party 111 is a procurement agent of a manufacturing line, necessary tool stock information can be obtained from the progress of tool wear and the number of times of tool exchange, and thus a consumable item such as a tool or a work material can be ordered from a tool manufacturer at an optimum timing.

When the relevant party 111 is a businessman, an operating rate including a failure or a repair status of the machining device 8 can be monitored from the customer, and it is possible to estimate a delivery date by knowing a current production status, and thus it is possible to immediately notify the customer of an accurate delivery date.

When the relevant party 111 works on design development, a portion of a bottleneck process in which many tools are exchanged can be understood from the information of the network 110, which can be used to improve a product design.

The present embodiment configured in this manner also achieves the same operational effect as that of the first embodiment. The present embodiment can be combined with any of the first and second embodiments.

### Fourth Embodiment

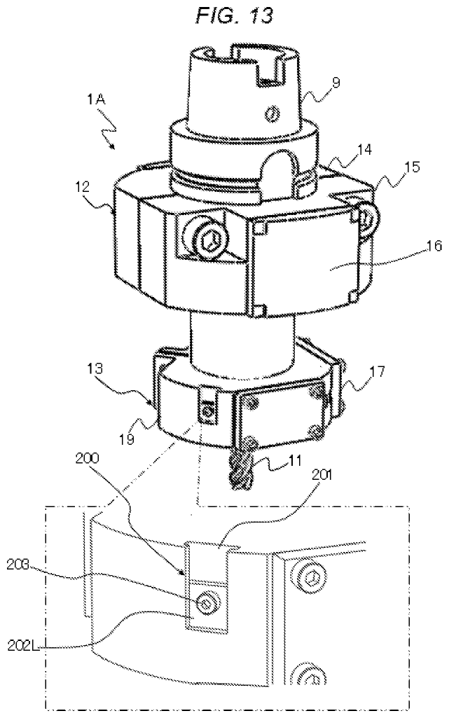

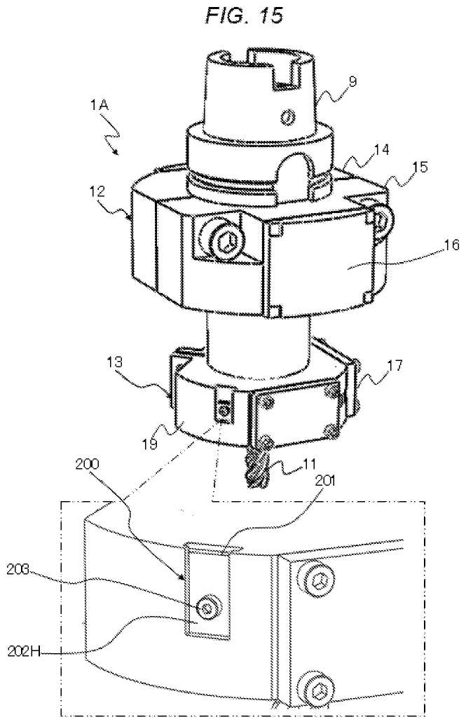

The fourth embodiment will be described with reference to FIGS. 13 and 15. In the present embodiment, a balance weight unit 200 is provided in a detection device 1A so that an oscillation (vibration) generated during the rotation of the tool holder 9 and the tool 11 is prevented.

The balance weight unit 200 is provided, for example, on an outer peripheral side of the sensor unit 13 at a position not covered with the sensor cover 17. The balance weight unit 200 includes, for example, a mounting unit 201 formed on the outer peripheral side of the sensor unit 13, a thin plate-shaped weight 202 attached to the mounting unit 201, and a fixing member 203 such as a bolt that detachably fixes the weight 202 to the mounting unit 201.

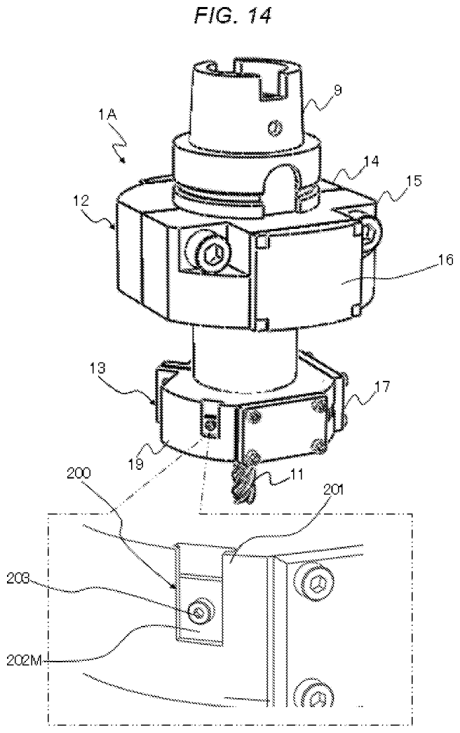

Weights 202 having different weights are prepared. In the present embodiment, a lightest weight 202L (FIG. 13), a medium weight 202M (FIG. 14), and a heaviest weight 202H are prepared. A weight having an appropriate weight may be used as necessary. For example, the weights 202 are made from the same metal material and have the same thickness dimension except for an only difference in length dimension. As a result, a difference in weight is a difference in the length dimension of the weight, and it is easy for the operator of the machining device 8 to visually confirm the weight. Although there is such an advantage, a configuration may be adopted in which plural thin plate-shaped weights are used in a stacked manner.

The present embodiment configured in this manner also achieves the same operational effect as that of the first embodiment. In the present embodiment, the balance weight unit 200 is provided on the outer peripheral side of the sensor unit 13. Therefore, even if oscillation (vibration) occurs during the rotation of the holder 9 and the tool 11 as a result of attaching the detection device 1 to the holder 9, the vibration can be reduced and machining accuracy of the machining device 8 can be stably maintained while the state of the tool 11 is detected with high accuracy.

In addition, the invention is not limited to the embodiments described above, and includes various modification examples. For example, the embodiments described above have been described in detail for easy understanding of the invention, and are not necessarily limited to those having all the described configurations. Further, a part of the configuration of one embodiment can be replaced with the configuration of another embodiment, or the configuration of one embodiment can be added to the configuration of another embodiment. In addition, a part of the configuration of each embodiment can be added to, deleted from, or replaced with other configurations.

What is claimed is:

1. A tool state detection system that detects a state of a tool attached to a machining device, the tool state detection system comprising:
a detection device which is formed separately from a tool holder that holds the tool and is detachably attached to the tool holder, the detection device being configured to detect the state of the tool and output measurement data; and
a data analysis device which provided to be communicable with the detection device, the data analysis device being configured to analyze the measurement data from the detection device.

2. The tool state detection system according to claim 1, wherein
the tool rotates about an axial direction of the tool holder, and
the detection device is detachably provided on an outer peripheral side of the tool holder and is coaxial with the tool holder.

3. The tool state detection system according to claim 2, wherein
the tool is provided on a tip end side of the tool holder, and
the detection device includes a sensor unit which is located on the tip end side of the tool holder and is configured to detect the state of the tool and output the measurement data, and a transmission and reception unit which is located away from the sensor unit on a base end side in the axial direction of the tool holder and is configured to receive the measurement data from the sensor unit and transmit the received measurement data to the data analysis device.

4. The tool state detection system according to claim 3, wherein
the sensor unit is smaller and lighter than the transmission and reception unit, and
the sensor unit and the transmission and reception unit are in a wired connection.

5. The tool state detection system according to claim 3, wherein
the transmission and reception unit includes a chargeable power source unit, and wirelessly transmits the measurement data from the sensor unit to the data analysis device.

6. The tool state detection system according to claim 3, wherein
the detection device is provided with a balance weight unit that prevents an oscillation of the tool holder during rotation.

7. The tool state detection system according to claim 6, wherein
the balance weight unit is detachably provided with weights having different weights.

8. The tool state detection system according to claim 7, wherein
the balance weight unit is provided in the sensor unit.

9. The tool state detection system according to claim 1, wherein
the data analysis device includes a reception device configured to receive measurement data from the detection device; a prior signal processing unit configured to perform predetermined prior signal processing on the measurement data received by the reception device, and a data analysis unit configured to analyze the measurement data processed by the prior signal processing unit.

10. The tool state detection system according to claim 9, wherein
the prior signal processing unit includes:
a setting parameter input unit configured to input a predetermined parameter set in advance;
a measurement start unit configured to receive the measurement data from the detection device according to the input predetermined parameter and start measurement;
a signal processing selection unit configured to select at least one signal processing method from among signal processing methods prepared in advance;
a signal processing execution unit configured to perform signal processing on data whose measurement has been started by the measurement start unit based on the selected signal processing method; and
a fast Fourier transform processing unit configured to perform fast Fourier transformation on the data processed by the signal processing execution unit.

11. The tool state detection system according to claim 10, wherein
the data analysis unit includes:
a feature amount selection unit configured to select a feature amount from data output from the prior signal processing unit;
an analysis parameter input unit configured to input an analysis parameter;
a feature amount calculation unit configured to calculate the selected feature amount based on the input analysis parameter;
a state determination unit configured to determine the state of the tool from the calculated feature amount; and
an analysis result output unit configured to output the determined state of the tool as an analysis result.

12. The tool state detection system according to claim 11, wherein
the data analysis unit inputs a control command to the machining device based on the analysis result.

13. The tool state detection system according to claim 1, wherein
the data analysis device is connectable to a plurality of detection devices, and provides a tool state analyzed based on measurement data received from each of the detection devices to an external computer terminal via a communication network.
